(19) United States
(12) Patent Application Publication
(10) Pub. No.: US 2006/0218549 A1
(43) Pub. Date: Sep. 28, 2006

(54) Method for application of portable software

(76) Inventors: Huei-Lan Hsu, Hsinchu (TW); Shih-Ter Li, Hsinchu (TW); Chen-Lung Chen, Hsinchu (TW); Chih-Chen Chang, Hsinchu (TW); Chiu-Hsueh Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/367,473

(22) Filed: Mar. 6, 2006

(30) Foreign Application Priority Data
Mar. 7, 2005 (CN) 200510053407.1

(51) Int. Cl. G06F 9/445

(52) U.S. Cl. 717/174

(57) ABSTRACT

A method for application of portable software stores a coordination program and at least an application program in a portable storage device. When the storage device is plugged to a computer system, the coordination program will be automatically run to set up a runtime environment of the application program (including carrying out authentication and authorization to ensure proper use of hardware and software). The application program can thus be executed in the computer system. After the user has finished the tasks, the application program is terminated, and the coordination program will restore the computer system to the original setting and automatically terminate itself. The user can then remove the storage device. In this way, easy usage and better integration can be accomplished, and the advantage of portable software can also be achieved.

### BACKGROUND OF THE INVENTION

1. Field of the Invention

The present invention relates to a method for application of software and, more particularly, to a method for application of portable software.

2. Description of Related Art

With long-lasting innovation and evolution of the electronic industry, portable electronic devices have greatly expanded no matter in type or quantity in the past few years. In a general computer system configuration, a personal computer is used as the host end, and other equipments are used as peripherals. Conventionally, a host end adapted with several peripherals is the mainstream of the current computer systems.

In the era of widespread use of the Internet, there exist two kinds of design logics for executing application programs in the client/server architecture: thin client and fat client. For the thin client design logic, the server takes the responsibility for all operations of application program and the client carries out their tasks by connecting to the server via network. The drawbacks of the thin client design logic include (1) a network is required for access, (2) less thorough operation design for users, and (3) more complicated development (e.g., today's Web programs). On the other hand, for the fat client design logic, most operations of application program are done by the client. The fat client design logic therefore has to face the drawbacks of large program, difficult to deploy and DLL hell (e.g., the conventional Windows programs).

U.S. Pat. No. 6,529,992 discloses how to store application programs in removable media. When a user plugs removable media to a computer, due to its lack of an online update mechanism, a two-stage authentication and authorization, and definitions of storage area (read-only and writable), the operation of plugging a removable media to a computer is impractical and failure in solving the problems derived from practical applications.

With the consumer's various demands, more convenient applications have to be developed to satisfy the consumers. The present invention changes the relation between computer and user, and turns the ownership of application program to user. Users own the application programs stored in any portable storage media. A user can launch the program only by connecting the storage media to a computer. The functions of safe use and program online-update can also be provided to achieve the goal of shared-computer era.

Therefore, the present invention aims to propose a method for application of portable software to solve the above drawbacks in the prior art.

### SUMMARY OF THE INVENTION

One object of the present invention is to provide a method for application of portable software, in which the autorun function of application program is used to allow users to be not limited by any computer, thereby being compatible with every computer.

Another object of the present invention is to provide a method for application of portable software, in which users own the software and possess the advantage of portable software, hence effectively solving the drawback that an application program has to be installed in a general computer system to be run.

Yet another object of the present invention is to provide a method for application of portable software, whereby users can connect to an operation platform via a standalone or networked environment to check the rights of hardware and software through the authentication and authorization mechanism from the operation platform, thereby preventing other unauthorized users from illegal use.

Still yet another object of the present invention is to provide a method for application of portable software, in which after the portable software connects to a computer system, it can update automatically to keep up with the latest version at any time.

To achieve the above objects, the present invention provides a method for application of portable software, which comprises the following steps. A plug-and-play storage device is selected for operating the whole method and storing the data. Then, the storage device is connected with a computer system capable of executing the instructions of the programs. Next, the hardware device authentication is performed and the storage device automatically executes a coordination program and updates programs from the computer system. After the user authorization, the coordination program sets up the mechanism of automatic register/unregister components and the environment configuration. The coordination program then invokes an application program to execute. After the application program has finished executing, the coordination program restores the environment setting and quits the executing state.

### BRIEF DESCRIPTION OF THE DRAWINGS

The various objects and advantages of the present invention will be more readily understood from the following detailed description when read in conjunction with the appended drawing, in which:

The FIGURE is a flowchart of the present invention.

### DETAILED DESCRIPTION OF THE PREFERRED EMBODIMENTS

In the present invention, software application programs are stored in portable storage media to allow users to be able to execute application programs in any computer. Computer software can therefore be carried by users along with the portable devices to enhance the convenience of software.

The procedures of executing an application program in a computer system include reading the application program from a storage device to the memory and executing the application program codes by CPU. The storage device is usually a hard disk drive, which can store application program codes almost permanently. The method for application of portable software of the present invention is based on the above principle. Under the premise of not disobeying the computer system architecture, the method provides improvements and additional functions for the application programs and also stores the application programs in a portable storage device. The portable storage device can be a flash memory or a USB pen drive with an interface of USB or IEEE1394. Besides, the portable storage device includes two storage areas: one for storing static data, and the other for storing program codes.

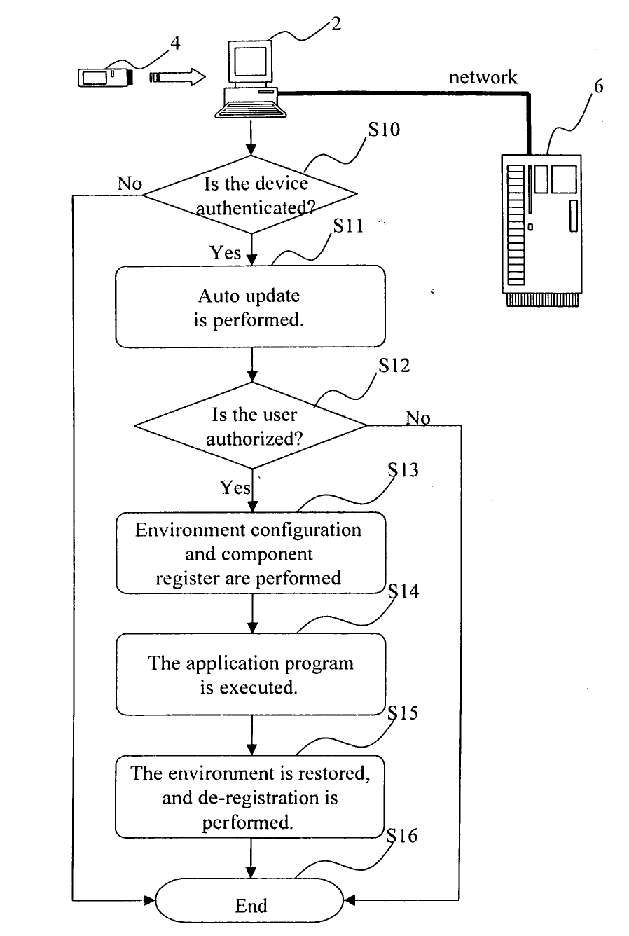

FIG. 1 is a flowchart of the present invention. As shown in the FIGURE, a coordination program and at least an application program are first stored in a USB pen drive 4, which is plugged to a terminal 2. The terminal 2 and a server 6 are computers connected by network. Next, the device authentication is performed through the ID code provided by the USB pen drive 4 to avoid duplication (Step S10). If the device authentication is successful, the OS of the terminal 2 automatically launches the coordination program in the USB pen drive 4 as a starting program. If the device authentication is unsuccessful, the coordination program cannot be executed, and the step turns to Step S16 to end the whole procedures. Abovementioned device authentication process can be done by the terminal 2 or the server 6. Auto update is performed (Step S11) as the device authentication is successful. The terminal 2 triggers the coordination program to update the application program and to download required information from the server 6 via network. Subsequently, the user authorization is performed by submitting a password in the application program to avoid duplication (Step S12). If the user authorization is successful, the coordination program can be executed. If the user certification is unsuccessful, the coordination program cannot be executed, and the step turns to Step S16 to end the whole procedures. Similarly, this service of user authorization can be done by the terminal 2 or the server 6. If both the device authentication and use authorization are passed, the coordination program performs autorun of common procedures and environment configuration (including environment registry, environment variables in runtime environment, component register and parameter setting), and monitors the executing process of any application program in the portable storage device (Step S13). Next, the coordination program invokes the application program and leave control to the application program for the user's operations on the terminal 2. The application program finishes its tasks through the resource of the computer system under the OS operation, provides all data required for operation and stores the generated data. After the user has finished operation and closed the application program, the environment is restored and unregistered (Step S15). As the application program terminates, the coordination program controls to restore the computer system to the original runtime environment and to release variable declarations, registered components and environment setting. Finally, in Step S16, after the USB pen driver 4 is removed from the terminal 2, no data will be left in the computer system and all computer system settings will not be changed.

The programs can be written with assembly language, firmware language or high-level language. The computer system for executing program can also be a standalone computer system. In this situation, updating for the application program and downloading for the required information from the server 6 in the above embodiment can be directly achieved by the standalone computer system without connecting to the network.

Therefore, the operation method of a split plug-and-play runtime environment, which is independent of the OS, allows the application programs of a portable device to be able to execute in every computer successfully. Through the present invention, computer software can be carried by users along with the portable devices to enhance the convenience of software. The drawback that an application program has to be installed in a common computer system for execution can thus be overcome. Moreover, other unauthorized people can be prevented from illegal use of the portable devices, hence enhancing the privacy.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method for application of portable software, said method comprising the steps of:
storing a coordination program and at least an application program in a storage device and connecting said storage device with a computer system;
authenticating said storage device;
authorizing the use right of said coordination program;
performing autorun of common procedures and environment configuration by said coordination program;
transferring the execution right to said application program by said coordination program; and
transferring the execution right to said coordination program and terminating said computer system.

2. The method for application of portable software as claimed in claim 1, wherein said storage device has a USB transmission interface or an IEEE 1394 transmission interface.

3. The method for application of portable software as claimed in claim 2, wherein said storage device is a USB pen driver or a flash memory.

4. The method for application of portable software as claimed in claim 1, wherein said computer system is a standalone computer system or a network operating system built with network architecture.

5. The method for application of portable software as claimed in claim 1, wherein the authentication of said storage device is accomplished through an ID code provided by said storage device.

6. The method for application of portable software as claimed in claim 1, further comprising the following steps after the step of authenticating said storage device:
triggering said coordination program by said computer system; and
updating said application program and downloading information from said computer system by said storage device.

7. The method for application of portable software as claimed in claim 1, wherein said storage device at least includes two storage areas for storing static data and for storing program data individually.

8. The method for application of portable software as claimed in claim 1, wherein the authentication of the use right of said coordination program is accomplished through an ID code stored by said coordination program.

9. The method for application of portable software as claimed in claim 1, wherein said coordination program is responsible for monitoring the situation that said application program executes instructions and procedures.

10. The method for application of portable software as claimed in claim 1, wherein said application program provides all data required for operation and stores generated data.

11. The method for application of portable software as claimed in claim 1, wherein before said coordination program terminates itself, it restores the environment setting previously made in said computer system to the original state.
